(19) United States
(12) Patent Application Publication
(10) Pub. No.: US 2006/0196821 A1
(43) Pub. Date: Sep. 7, 2006

(54) Filter for absorbing water

(76) Inventor: Leslie Donald Selsdon, London (GB)

Correspondence Address: Iandiorio & Teska, 260 Bear Hill Road, Waltham, MA, 02451-1018, US

(21) Appl. No.: 10/551,402

(22) PCT Filed: Mar. 24, 2004
(86) PCT No.: PCT/GB04/01259

§ 371 Date: Sep. 29, 2005

(30) Foreign Application Priority Data
Mar. 31, 2003 (GB) 0307397.0

(51) Int. Cl. B01D 35/28

(52) U.S. Cl. 210/435; 210/446; 210/510.1

(57) ABSTRACT

A filter (2) comprising a body (4), an inlet (6) for a liquid passing into the body (4), an outlet (8) for the liquid passing out of the body (4), and a foam material (10) in the body (4) for filtering the liquid as the liquid passes through the body (4) and also for absorbing water in the liquid.

This invention relates to a filter, for example an oil filter.

Filters for filtering different types of liquids are well known. Thus, for example, oil filters are well known and used for filtering oil for equipment such for example as hydraulic circuits and engines. Often equipment utilising oil and oil filters is used in temperature conditions which are hot during the day and substantially colder at night. Such a drop in temperature at night can lead to condensation of water from the atmosphere and this water can be taken up by the oil. There are many instances where it is not acceptable to have more than trace elements of water in oil. Thus, for example, equipment such as tractors and earth moving equipment often utilises closed hydraulic circuits. Too much water in the hydraulic circuits can lead to the oil bubbling or boiling, and it can also lead to pistons prematurely collapsing and seals prematurely failing. In addition, the hydraulic circuits tend to suffer from an accumulation of dirt which manifests itself as silt and which can damage component parts of the equipment. Liquids used as engine fuels also should not contain water.

It is an aim of the present invention to provide a filter which is able to reduce the above mentioned problems.

Accordingly, in one non-limiting embodiment of the present invention there is provided a filter comprising a body, an inlet for a liquid passing into the body, an outlet for the liquid passing out of the body, and a foam material in the body for filtering the liquid as the liquid passes through the body and also for absorbing water in the liquid.

The filter of the present invention is advantageous in that the foam material filters the liquids and also absorbs the water in the liquid. If the liquid, for example oil, also contains silt, then this silt may also be removed. The foam material is advantageous in that it contains a large volume of air and thus has a large operative surface area. The foam material may be regarded as having a honeycomb structure. The foam material may be 98% by volume air. The structure of the foam material thus gives very effective filtration and water absorbing.

The equipment using the filtered and purified liquid may be hydraulic circuits for various devices, including tractors and earth moving equipment, with such circuits being closed circuits. Alternatively, the equipment may be engines such for example as internal combustion engines where oil is supplied to the engines in what may be regarded as an open circuit.

Generally, the filter can be a filter for any suitable and appropriate purpose. Thus, for example, the filter may be used for filtering a fuel in order to remove water from the fuel. The filter may be used to filter water from various types of fuel including petrol, but especially including diesel fuel and methanol where water in the diesel fuel and methanol can present something of a problem. If desired, the filter may be used for removing water from gases.

The filter may be produced to be smaller than known filters of comparable filtering capacity. Thus, the filter of the present invention may be of especial use in engines where space is a problem.

If desired, the filter may be used in the fuel line between a fuel tank and a large diesel engine, for example engines as employed in excavators, large marine vehicles, and large electrical generator apparatus.

The foam material is preferably a woven foam material.

The foam material may be a polymer material.

The foam material may be a foam material which is not hygroscopic. A presently preferred such material is that manufactured by the Camelot Company. Because the foam material is not hygroscopic, it does not become wet in humid atmospheres and so there is no need to protect the foam material, for example by encapsulating it, from the effects of the atmosphere. An alternative less preferred foam material which can be used and which is in fact hygroscopic is that sold under the trade mark Luquafleece by BASF Superabsorbents Ltd. of Birkenhead, United Kingdom.

The foam material may be in pieces which are positioned in the body.

Alternatively, the foam material may form part of a cartridge which is positioned in the body. Advantageously, the cartridge may be a disposable cartridge so that the body of the filter can continue to be used with different cartridges. Used cartridges can simply being replaced by new cartridges. With such an arrangement, a pack could be sold with the filter comprising the body, the inlet and the outlet, and a plurality of the disposable cartridges for use with the same body. If desired however, the cartridge could be a permanent cartridge.

The cartridge, for example the disposable cartridge, may include a support member for the foam material. The support member may have a plurality of apertures along its length for enabling the liquid to pass through the support member.

In one embodiment of the invention, the foam material is positioned around the outside of the support member. In this embodiment of the invention, the foam material is preferably in sheet form and it is wrapped around the outside of the support member.

In an alternative embodiment of the invention, the foam material is positioned inside the support member. In this case, the foam material may be in sheet form or in the form of pieces. The filter may include end screen members for retaining the foam material in the support member.

The filter may include a non-return valve. The non-return valve may be positioned in an end part of the filter.

The filter of the present invention may be of any suitable and appropriate construction. The body of the filter may be made of a plastics material. Any suitable and appropriate plastics materials may be employed. The plastics materials may be transparent for see-through purposes, or non-transparent. The body of the filter may also be made of a metal.

The filter may be one having a separate inlet and outlet. The separate inlet and outlet are preferably formed for push on hose connections held in place by clips such as jubilee clips. Other formations may be employed so that, for example, the separate inlet and outlet may be for receiving screw fittings or snap fittings. The filter may alternatively have a single combined inlet and outlet, and such a filter may be one in which the combined inlet and outlet is an internally threaded aperture for enabling the filter to be a screw threaded connection to a circuit, for example a hydraulic circuit.

It may be advantageous to know when the filter is blocking or a system containing the filter is blocking. Pressure sensing means such for example as a pressure differential gauge can be built in, so that a user can constantly monitor system conditions. The monitoring may be effected locally, or even remotely, for example for hospital emergency standby generators.

The use of the foam material is also advantageous in that the foam material does not dictate the shape of the filter or component parts of the filter. Thus the filter can be made in a wide variety of shapes. This can be advantageous in causing the filter to be made in a shape, for example a star shape, that gives an oil cooling function. With such a shape, the filter can act as an oil cooler. With sufficient oil cooling from the filter, hitherto used radiators could be reduced in size or even dispensed with.

Embodiments of the invention will now be described solely by way of example and with reference to the accompanying drawings in which:

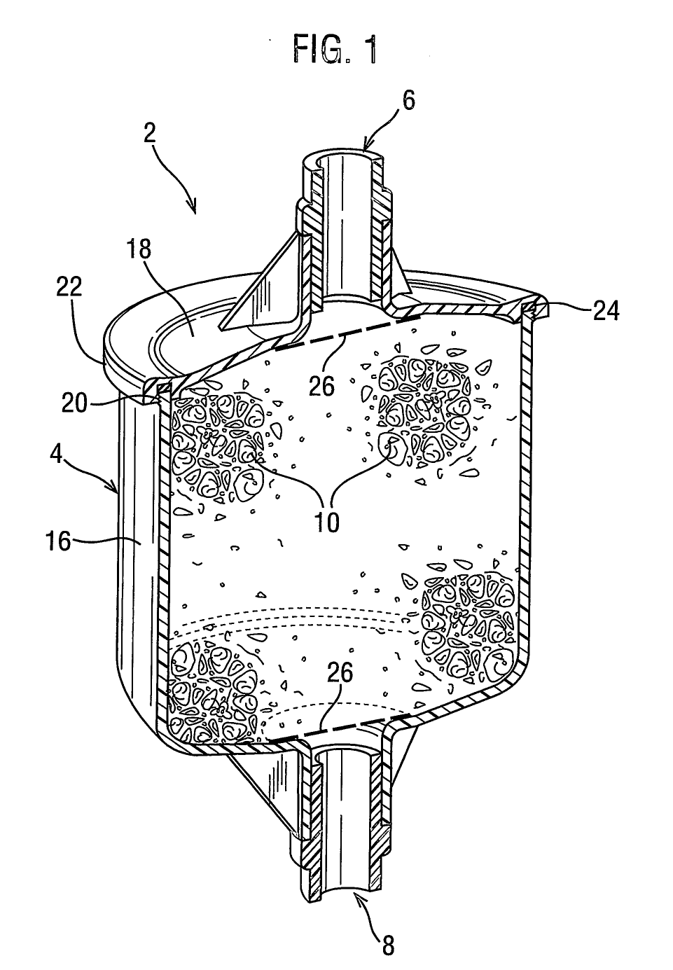

FIG. 1 is a cross section through a first oil filter;

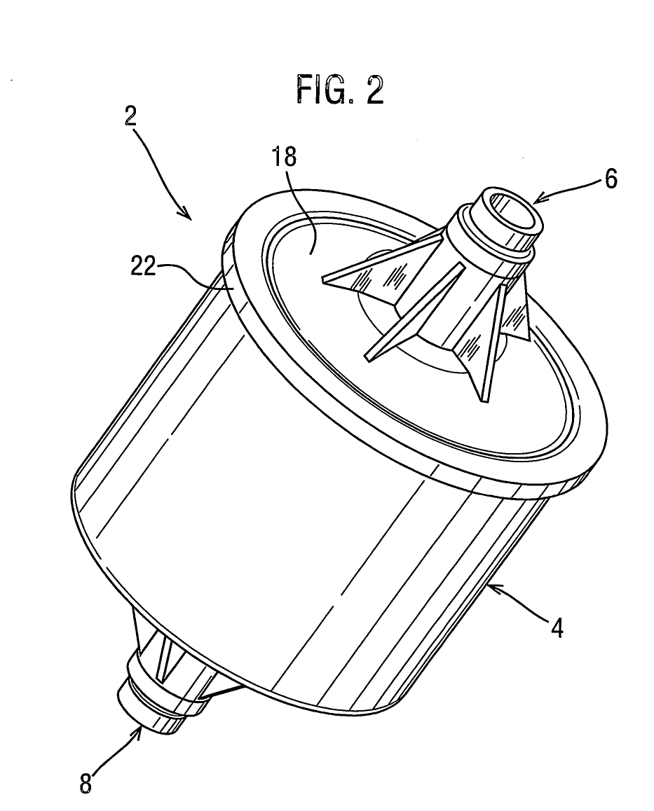

FIG. 2 is a perspective view of the oil filter shown in FIG. 1;

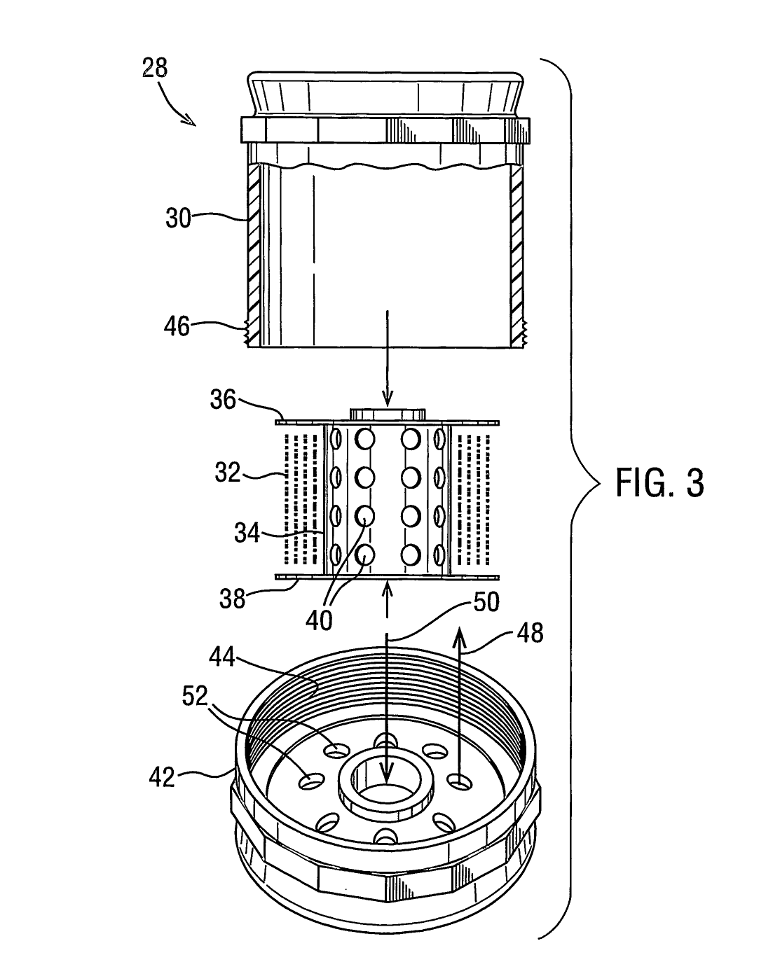

FIG. 3 is an exploded view of a second oil filter;

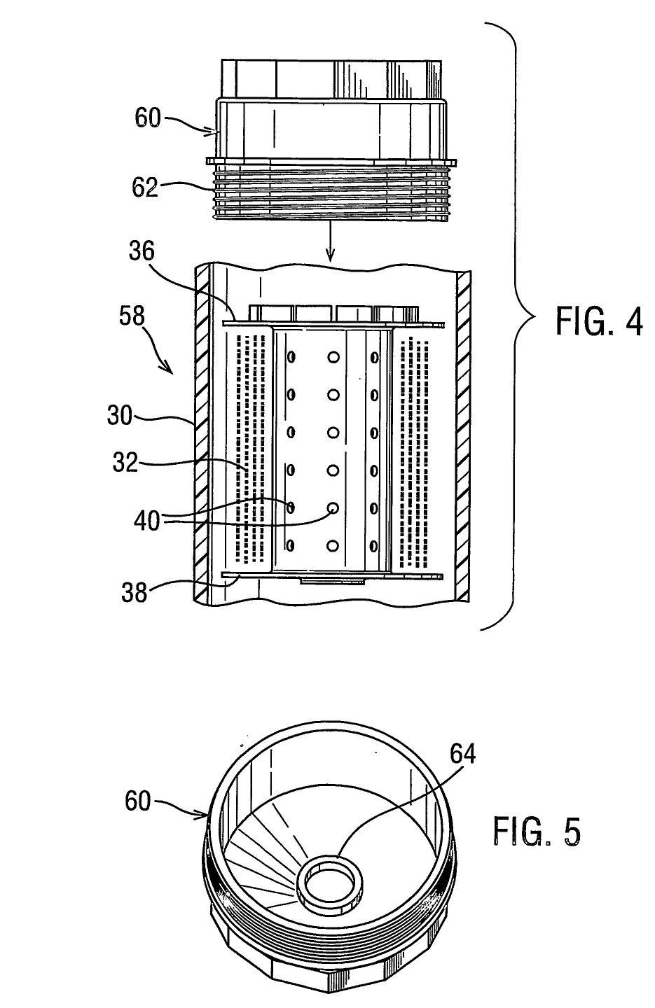

FIG. 4 is a an exploded view of a third oil filter;

FIG. 5 is a perspective view of a part of the third oil filter shown in FIG. 4.

Referring to FIG. 1, there is shown an oil filter 2 comprising a body 4, an inlet 6 for oil passing into the body 4, an outlet 8 for oil passing out of the body 4, and foam material 10 in the body 4 for filtering the oil as it passes through the body 4, and also for absorbing water and silt in the oil. The water and the silt are generated in the oil during use of the oil filter in a hydraulic circuit for equipment (not shown). The oil filter 2 is advantageously able to sit direct in a hydraulic fuel tank (not shown) if desired. The oil filter 2 is also able to be used for road vehicle engines.

The foam material 10 is a woven polymer foam material. The woven polymer foam material is non-hygroscopic. The foam material 10 is in small pieces as shown.

The body 4 is made of a plastics material. The body 4 comprises a main body part 16 and a cap part 18 which screws to the main body part 16 via screw threads 20. The cap part 18 may have a grip portion 22 for helping the cap part 18 to be tightened and un-tightened from the main body part 16.

An oil seal 24 is provided for preventing loss of oil from between the main body part 16 and the cap part 18 when the oil filter 2 is operating under hydraulic pressure.

The main body part 16 and the cap part 18 may be made as mouldings, for example from glass reinforced nylon.

The oil filter 2 may includes a non-return valve (not shown). The non-return valve acts as an anti-drain valve.

A screen 26 are positioned as shown in order to retain the pieces of the foam material 10 in the body 4

Reference will now be to the following Example in which new oil with various additives was twice filtered through an oil filter 2 of the construction shown in FIG. 1. A control batch of the oil was passed through an oil filter as shown as FIG. 1 but without the foam material. Another portion of the oil was passed through the oil filter 2 exactly as shown in FIG. 1, that is with the foam material 10. The results obtained are given hereinbelow.

TABLE 1
OIL PASSED THROUGH FILTER
WITH NO FOAM MATERIAL

| Additives | New Oil | Filtered Once | Filtered Twice |
|---|---|---|---|
| Iron | 5 | 4 | 4 |
| Chromium | 0 | 0 | 0 |
| Aluminium | 0 | 0 | 1 |
| Copper | 1 | 1 | 1 |
| Lead | 4 | 5 | 4 |
| Nickel | 0 | 0 | 0 |
| Tin | 0 | 0 | 0 |
| Manganese | 0 | 0 | 0 |
| Titanium | 0 | 0 | 0 |
| Silver | 0 | 0 | 0 |
| Molybdenum | 0 | 0 | 0 |
| Zinc | 405 | 403 | 319 |
| Phosphorus | 270 | 269 | 263 |
| Calcium | 38 | 35 | 35 |
| Barium | 0 | 0 | 0 |
| Magnesium | 1 | 1 | 1 |
| Silicon | 1 | 2 | 1 |
| Sodium | 3 | 6 | 6 |
| Boron | 1 | 1 | 1 |
| Vanadium | 0 | 0 | 0 |
| Water | 163 ppm | 123 ppm | 209 ppm |

TABLE 2
OIL PASSED THROUGH FILTER WITH
FOAM MATERIAL (FIGS. 1 and 2).

| Additives | New Oil | Filtered Once | Filtered Twice |
|---|---|---|---|
| Iron | 0 | 0 | 0 |
| Chromium | 0 | 0 | 0 |
| Aluminium | 0 | 0 | 0 |
| Copper | 0 | 0 | 0 |
| Lead | 0 | 2 | 1 |
| Nickel | 0 | 0 | 0 |
| Tin | 0 | 0 | 0 |
| Manganese | 0 | 0 | 0 |
| Titanium | 0 | 0 | 0 |
| Silver | 0 | 0 | 0 |
| Molybdenum | 0 | 0 | 0 |
| Zinc | 426 | 441 | 547 |
| Phosphorus | 269 | 266 | 281 |
| Calcium | 26 | 27 | 28 |
| Barium | 0 | 0 | 0 |
| Magnesium | 0 | 1 | 1 |
| Silicon | 4 | 5 | 4 |
| Sodium | 0 | 0 | 0 |
| Boron | 0 | 0 | 0 |
| Vanadium | 0 | 0 | 0 |
| Water | 84 ppm | 91 ppm | 84 ppm |

It will be noted from Table 1 that the additives of zinc, phosphorus and calcium are at an acceptable level, both in the new oil and after the oil had been filtered twice. However, the amount of water in the new oil was 163 ppm but this increased to 209 ppm at the second filtering. This amount of water in the oil was not acceptable.

It will be noted from Table 2 that the additives of zinc, phosphorus and calcium remained at acceptable levels and also that the water remained at an acceptable level. More specifically, the water content of the oil after the second pass through the oil filter 20 was exactly the same as the water content of the new oil, namely 84 ppm. Thus the oil filter 2 with the foam material 10 maintained the water content of the oil after two passes through the oil filter 2 at exactly the same level of parts per million as it was initially in the new oil. Further, the use of the foam material 10 did not adversely affect the additives in the oil and thus the additives were able to perform the function which they were intended to by the oil manufacturer. Also, the use of the foam material 10 absorbed silt in the oil, this not being shown in Table 2. The foam material 10 acts as a purifier to purify the oil from the water and the silt.

The filter 2 is also advantageous in that it uses snap-on fittings for the inlet 6 and the outlet 8. The snap-on fittings are cheaper than screw threads to manufacture, they require simpler tooling, and they are easier to use than threaded fittings. With threaded fittings, there is a tendency for people fitting the filters to over-tighten the threads and/or to cross thread the threads.

The filter 2 is also advantageous in that the screens 26 can easily be located adjacent the inlet 6 and the outlet 8 by welding. The welding may be ultrasonic welding, for example where the body 4 and the illustrated lid 4 are made of plastics materials.

If desired, the oil filter 2 can be made such that the body 4 and/or the lid 4 are made of a transparent plastics material so that it is possible to see inside the oil filter 2 and see how the foam material 10 is working.

The oil filter 2 may be manufactured as a cheap, easily installed and highly efficient disposable filter. By removing water from the oil, damage to equipment can be avoided, which in turn helps to reduce warranty claims for equipment manufacturers.

Referring now to FIG. 3 there is shown a filter 28 comprising a body 30, an inlet for liquid passing into the body 30, and outlet for liquid passing out of the body 30, and a foam material 32 for filtering the liquid as it passes through the body 30 and also for absorbing water in the liquid. The filter 28 shown in FIG. 3 is advantageously employed as a filter for an engine for a road vehicle such for example as car.

The foam material 30 is a woven polymer foam material. The foam material 30 is in sheet form which is wound around a support member 34. The support member 34 with the foam material 30 forms a disposable cartridge which can be replaced in the body 30 when it becomes used up.

The support member 30 has top and bottom flanges 36, 38 respectively for helping to locate the wound foam material 32, and also for ensuring that the foam material 32 does not slip longitudinally on the support member 34.

The support member 34 has a plurality of apertures 40 along its longitudinal length. These apertures enable the filtered liquid, for example filtered oil, to pass through the wall of the support member 34 and be filtered by the foam material 32. The flow and return can be of any suitable and appropriate way so that the material being filtered could flow radially outwardly or radially inwardly with respect to the support member 34.

Also shown in FIG. 3 is a bottom part 42 of the filter 28. The bottom part 32 has an internally screw-threaded portion 44 which screws to an externally screw-threaded portion 46 of the body 30. Oil flow through the filter 28 is shown by arrow 48, and oil return through the oil filter 28 is shown by arrow 50. The oil flow shown by arrow 48 is such that the oil passes through apertures 52 in the bottom part 42. These apertures 42 are advantageously covered with a diaphragm (not shown). Thus, when the engine or other piece of apparatus is not operating, the diaphragm retains oil in the oil filter 28 because it prevents the oil from running out through the apertures 52. Thus, at start-up conditions, the oil filter 28 is always full of oil and there is no period when the engine could be starved of oil for lubrication purposes.

FIG. 3 shows schematically part of the engine 54. The engine 54 is provided with a threaded stud 56 onto which the oil filter 28 is screwed.

FIG. 4 shows a third oil filter 58 which also employs a replaceable cartridge similar to that shown in FIG. 3. Similar parts have been given the same reference numerals for ease of comparison and understanding.

In FIG. 4, there is shown a top part 60 which has a threaded portion 62 for enabling the top part 60 to be screwed into position on the top of the body 30 of the oil filter 58.

FIG. 5 is a perspective view of the top part 60 and it will be seen that the top part 60 has a boss 64 for receiving a pressure relief valve (not shown). The pressure relief valve is employed for ensuring that, in the event of a blockage, the pressure relief valve will enable oil still to be passed to the engine.

It is to be appreciated that the embodiments of the invention described above with reference to the accompanying drawings have been given by way of example only and that modifications may be effected. Thus, for example, the bodies of the oil filters are preferably made of a plastics material so that the oil filters can be recycled. The oil filters can however be made of other materials such as metals if desired. The filters may be such that it is secured in position by means other than screw threads. The filters can be mounted in any suitable and appropriate position relative to a hydraulic circuit.

Where a pressure relief valve is employed, then the pressure relief valve may comprise a ball valve and a spring for biasing the ball valve to a normally closed position against a valve seat. If the filter means should become blocked with filtered impurities from the oil, then the oil may not be able to get through the filter. Any engine or other piece of equipment requiring the oil could thus be starved of the oil. If the oil filter becomes blocked, then pressure will rise in the oil filter. This will cause the oil to flow through apertures and force the ball valve off its seat. A bore will then be opened and the oil can flow along the passageway to the outlet. Thus, the oil will still be provided to an engine or whatever else requires the oil, even in the event of a blockage in the filter.

The pressure relief valve is advantageously located as shown in a cap part of the oil filter. Thus the cap part can be removed from the main body part in order to allow the foam material, for example in the form of a cartridge to be replaced. The use of replacement cartridges can thus be effected without having to throw away the main body or the cap part of the filter. These parts are relatively expensive, especially when they contain the pressure relief valve. Thus the oil filter of the present invention can be extremely cheap to maintain. Liquids other than oil may be filtered.

If desired, in the filter of the invention, a magnet may be employed to attract ferrous particles out of the oil. If a magnet is employed, then the magnet is preferably located in the cap or lid of the filter. Thus the magnet can easily be retained if the filter is opened up and provided with new water absorbing polymer material. The cap or lid may be a bayonet fitting to the main body instead of being a screw threaded fit.

In FIGS. 1 and 2, the inlet 6 and the outlet 8 may be reversed. If desired, the oil filter 2 may be rotated through 90° from the position shown in FIG. 1 so that the oil filter 2 may be installed horizontally rather than vertically as shown in FIG. 1.

1. A filter comprising a body, an inlet for liquid passing into the body, an outlet for the liquid passing out of the body, and a foam material in the body for filtering the liquid as the liquid passes through the body and also for absorbing water in the liquid.

2. A filter according to claim 1 in which the foam material is a woven foam material.

3. A filter according to claim 1 in which the foam material is a polymer foam material.

4. A filter according to claim 1 in which the foam material is in pieces which are positioned in the body.

5. A filter according to claim 1 in which the foam material forms part of a cartridge which is positioned in the body.

6. A filter according to claim 5 in which the cartridge is a disposable cartridge.

7. A filter according to claim 5 in which the cartridge includes a support member for the foam material.

8. A filter according to claim 7 in which the support member has a plurality of apertures along its length for enabling the liquid to pass through the support member.

9. A filter according to claim 7 in which the foam material is positioned around the outside of the support member.

10. A filter according to claim 9 in which the foam material is in sheet form and is wrapped around the outside of the support member.

11. A filter according to claim 7 in which the foam material is positioned inside the support member.

12. A filter according to claim 11 in which the foam material is in sheet form or is in the form of pieces.

13. A filter according to claim 12 and including end screen members for retaining the foam material in the support member.

14. A filter according to claim 1 and including a non-return valve.

15. A filter according to claim 14 in which the non-return valve is positioned in an end part of the filter.

16. A filter according to claim 1 in which the outlet is an internally threaded outlet for enabling the filter to be a screw threaded connection to a circuit.
